(19) United States
(12) Patent Application Publication
(10) Pub. No.: US 2026/0338432 A1
(43) Pub. Date: Oct. 29, 2026

(54) PROCESS LIQUID FILTER SYSTEM FOR HVAC&R SYSTEM

(71) Applicant: Johnson Controls Tyco IP Holdings LLP, Milwaukee, WI (US)

(72) Inventor: Lars Skovlund Andersen, Maarslet (DK)

(21) Appl. No.: 19/120,192

(22) PCT Filed: Oct. 10, 2023
(86) PCT No.: PCT/US2023/034827

§ 371 Date: Apr. 10, 2025

(30) Foreign Application Priority Data
Oct. 10, 2022 (DK) PA202270490

(51) Int. Cl. F25B 43/00; B01D 29/52; B01D 29/66; B01D 35/12; B01D 35/157; B01D 37/00; F25B 9/00; F25B 41/24; F25B 43/04

(52) U.S. Cl. CPC F25B 43/003; B01D 29/52; B01D 29/668; B01D 35/12; B01D 35/1573; B01D 37/00; F25B 41/24; F25B 43/043; B01D 2201/16; F25B 9/002

(57) ABSTRACT

A process liquid filter system for a heating, ventilation, air conditioning, and refrigeration (HVAC&R) system includes a plurality of process liquid filters arranged in parallel with one another relative to flow of process liquid through the process liquid filter system, where each process liquid filter of the plurality of process liquid filters includes an inlet valve configured to receive unfiltered process liquid and an outlet valve configured to discharge filtered process liquid. The process liquid filter system also includes a purge system having a respective purge inlet valve coupled to each process liquid filter of the plurality of process liquid filters, where each respective purge inlet valve is configured to control flow of a purge gas into the process liquid filter corresponding to the respective purge inlet valve, and a respective purge discharge valve coupled to each process liquid filter of the plurality of process liquid filters, where each respective purge discharge valve is configured to discharge the filtered process liquid from the process liquid filter corresponding to the respective purge discharge valve.

### CROSS-REFERENCE TO RELATED APPLICATIONS

This application claims priority from and the benefit of Danish Patent Application No. 202270490, entitled “AN OIL FILTER UNIT FOR UNINTERRUPTED OIL SUPPLY,” filed Oct. 10, 2022, which is herein incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, air conditioning, and refrigeration (HVAC&R) systems, such as vapor compression systems, utilize a working fluid (e.g., a refrigerant) that changes phases between vapor, liquid, and combinations thereof in response to exposure to different temperatures and pressures within components of the HVAC&R system. The HVAC&R system may include a working fluid circuit configured to place the working fluid in a heat exchange relationship with a conditioning fluid (e.g., water) and may deliver the conditioning fluid to conditioning equipment and/or a conditioned environment serviced by the HVAC&R system. For example, the HVAC&R system may include a heat exchanger configured to receive the working fluid and the conditioning fluid to place the working fluid in the heat exchange relationship with the conditioning fluid. The conditioning fluid may be directed from the heat exchanger to other equipment, such as air handlers, to condition other fluids, such as air in a building. The HVAC&R system may also include other components, such as a compressor configured to pressurize the working fluid and direct the working fluid through the HVAC&R system.

In many applications, the HVAC&R system may include a process liquid system configured to supply a process liquid to components of the HVAC&R system, such as the compressor. The process liquid system may include a process liquid filter system configured to filter the process liquid, such as to remove impurities or other particles from the process liquid. Process liquid filter systems may include filters that are periodically cleaned, replaced, or otherwise maintained. Unfortunately, performance of process liquid filter system maintenance procedures typically involves suspending operation of the HVAC&R system. In other words, during process liquid filter system maintenance procedures, traditional HVAC&R systems are unable to operate to support, meet, or satisfy a load on the HVAC&R system.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a process liquid filter system for a heating, ventilation, air conditioning, and refrigeration (HVAC&R) system includes a plurality of process liquid filters arranged in parallel with one another relative to flow of process liquid through the process liquid filter system, where each process liquid filter of the plurality of process liquid filters includes an inlet valve configured to receive unfiltered process liquid and an outlet valve configured to discharge filtered process liquid. The process liquid filter system also includes a purge system having a respective purge inlet valve coupled to each process liquid filter of the plurality of process liquid filters, where each respective purge inlet valve is configured to control flow of a purge gas into the process liquid filter corresponding to the respective purge inlet valve, and a respective purge discharge valve coupled to each process liquid filter of the plurality of process liquid filters, where each respective purge discharge valve is configured to discharge the filtered process liquid from the process liquid filter corresponding to the respective purge discharge valve.

In another embodiment, a method for operating a process liquid filter system for a heating, ventilation, air conditioning, and refrigeration (HVAC&R) system includes blocking flow of a process liquid through a first process liquid filter of the process liquid filter system and simultaneously directing flow of the process liquid through a second process liquid filter of the process liquid filter system to remove impurities from the process liquid, where the first process liquid filter and the second process liquid filter are arranged in parallel with one another relative to flow of the process liquid through the process liquid filter system, enabling flow of the process liquid through the first process liquid filter of the process liquid filter system, blocking flow of the process liquid through the second process liquid filter subsequent to enabling flow of the process liquid through the first process liquid filter, purging the process liquid from the second process liquid filter, and replacing a filter media of the second process liquid filter with a new filter media.

In another embodiment, a process liquid filter system for a heating, ventilation, air conditioning, and refrigeration (HVAC&R) system includes an inlet manifold configured to receive unfiltered process liquid, an outlet manifold configured to discharge filtered process liquid from the process liquid filter system, and a plurality of process liquid filters arranged in parallel with one another relative to flow of process liquid through the plurality of process liquid filters, where each process liquid filter of the plurality of process liquid filters includes an inlet valve configured to receive the unfiltered process liquid from the inlet manifold and an outlet valve configured to discharge the filtered process liquid to the outlet manifold. Each process liquid filter of the plurality of process liquid filters includes a purge inlet valve configured to control flow of a purge gas into the process liquid filter, a purge discharge valve configured to discharge the filtered process liquid from the process liquid filter, and a drain valve configured to discharge the unfiltered process liquid from the process liquid filter.

### DRAWINGS

Various aspects of this disclosure may be better understood upon reading the following detailed description and upon reference to the drawings in which:

FIG. 1 is a perspective view of a building utilizing an embodiment of a heating, ventilation, air conditioning, and refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of the vapor compression system of FIG. 2, in accordance with an aspect of the present disclosure;

FIG. 4 is a schematic of an embodiment of the vapor compression system of FIG. 2, in accordance with an aspect of the present disclosure;

FIG. 5 is a schematic of an embodiment of an HVAC&R system including a process liquid system, in accordance with an aspect of the present disclosure;

FIG. 6 is a perspective view of an embodiment of a process liquid filter system of an HVAC&R system, in accordance with an aspect of the present disclosure;

FIG. 7 is a perspective view of an embodiment of a process liquid filter system of an HVAC&R system, in accordance with an aspect of the present disclosure;

FIG. 8 is a perspective view, taken within line 8-8 of FIG. 6, of a portion of an embodiment of a process liquid filter system, in accordance with an aspect of the present disclosure;

FIG. 9 is a perspective view, taken within line 9-9 of FIG. 7, of a portion of an embodiment of a process liquid filter system, in accordance with an aspect of the present disclosure;

FIG. 10 is a perspective view of an embodiment of a process liquid filter system of an HVAC&R system, illustrating operation of the process liquid filter system during a filter maintenance procedure, in accordance with an aspect of the present disclosure;

FIG. 11 is a perspective view of an embodiment of a process liquid filter system of an HVAC&R system, illustrating operation of the process liquid filter system during a filter maintenance procedure, in accordance with an aspect of the present disclosure; and

FIG. 12 is a flow chart of an embodiment of a method for operating a process liquid filter system, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

Embodiments of the present disclosure relate to a heating, ventilation, air conditioning, and refrigeration (HVAC&R) system, such as a heat pump system or a chiller system, having a vapor compression system. The vapor compression system (e.g., a vapor compression circuit) may circulate a working fluid (e.g., a heat transfer fluid, a refrigerant, ammonia) through a working fluid circuit in order to cool and/or heat a conditioning fluid (e.g., air, water, brine). The HVAC&R system may then direct the conditioning fluid to other equipment to condition a space and/or a component serviced by the HVAC&R system. The vapor compression system may include one or more heat exchangers configured to enable transfer of thermal energy (e.g., heat) between the working fluid and another fluid, such as the conditioning fluid. For example, the vapor compression system may include an evaporator and/or a condenser configured to place the working fluid in a heat exchange relationship with the conditioning fluid to enable heat transfer from the conditioning fluid to the working fluid in order to cool and/or heat the conditioning fluid.

The vapor compression system may also include a compressor (e.g., a screw compressor) configured to pressurize and circulate the working fluid through the working fluid circuit and, thus, enable the transfer of thermal energy between the working fluid and the fluid to be conditioned via the condenser and/or the evaporator. The compressor may operate to drive or force flow of the working fluid along the working fluid circuit. As will be appreciated, the compressor may include one or more components, such as one or more screws, an impeller, one or more pistons, a crankshaft, and/or other components, configured to move during operation of the compressor. In some embodiments, the compressor may utilize a process liquid (e.g., oil) to facilitate improved operation of the system (e.g., compressor) by enabling lubrication, sealing, and cooling of the components of the system. To this end, the HVAC&R system may include a process liquid system configured to supply the process liquid (e.g., enhancing liquid, oil) to the compressor. The process liquid may be any suitable liquid (e.g., non-phase-changing liquid) configured to enhance operation of the compressor by providing lubrication, sealing, cooling, and/or other enhancements. The process liquid system may also be configured to condition the process liquid for use within the compressor. For example, the process liquid system may include a process liquid cooler configured to reduce a temperature of the process liquid before the process liquid is supplied or re-supplied to the compressor. The process liquid system may also include a filter system configured to filter the process liquid, such as to remove impurities or other particles that may become entrained within the process liquid. The filter system may include one or more filters configured to receive a respective flow of process liquid, remove particles from the process liquid, and discharge the process liquid for supply to the compressor.

As will be appreciated, it may be desirable and/or beneficial to periodically perform maintenance procedures on the filter system to enable proper (e.g., efficient) operation of the compressor and the HVAC&R system. For example, a filter component (e.g., filter media) of a filter may be removed, cleaned, replaced, re-conditioned, and/or otherwise adjusted to restore and/or improve operational attributes or properties of the filter. Unfortunately, in existing systems, performance of maintenance procedures on the filter system typically involves suspending operation of the HVAC&R system, such that the HVAC&R system is unable to service a load on the HVAC&R system. For example, the HVAC&R system, including the compressor, may be shut down while the process liquid system and/or components thereof are disassembled, removed, replaced, or otherwise maintained. Moreover, existing maintenance procedures for process liquid systems may introduce undesirable risks, complications, and/or costs. For example, during filter repair and/or replacement, process liquid within the filter system may be discarded and replaced with new process liquid, which may increase costs associated with maintenance and operation of the HVAC&R system. Additionally, some filter systems may be susceptible to wear or degradation during maintenance procedures.

Thus, it is now recognized that improved process liquid systems and methods, as well as improved filter systems for process liquid systems, of HVAC&R systems are desired. Accordingly, the present disclosure is directed to a process liquid system for an HVAC&R system that includes a filter system with a plurality of filters (e.g., filter modules, filter assemblies) configured to enable continued operation of the HVAC&R system during maintenance procedures performed on the filter system. For example, the filter system may include at least one filter of the plurality of filters that is idle (e.g., does not operate to filter process liquid) during normal operation of the HVAC&R system, such as time periods in which maintenance procedures are not performed. During a maintenance procedure, the at least one filter may be utilized to filter the process liquid while a maintenance procedure is performed on another filter of the plurality of filters. The present techniques also enable a reduction in discarded process liquid that may otherwise be drained or discharged during maintenance procedures. Thus, the present techniques enable continued operation of the HVAC&R system to service a load on the HVAC&R system while also reducing costs and/or complications associated with traditional process liquid systems. Details the present techniques are described further below.

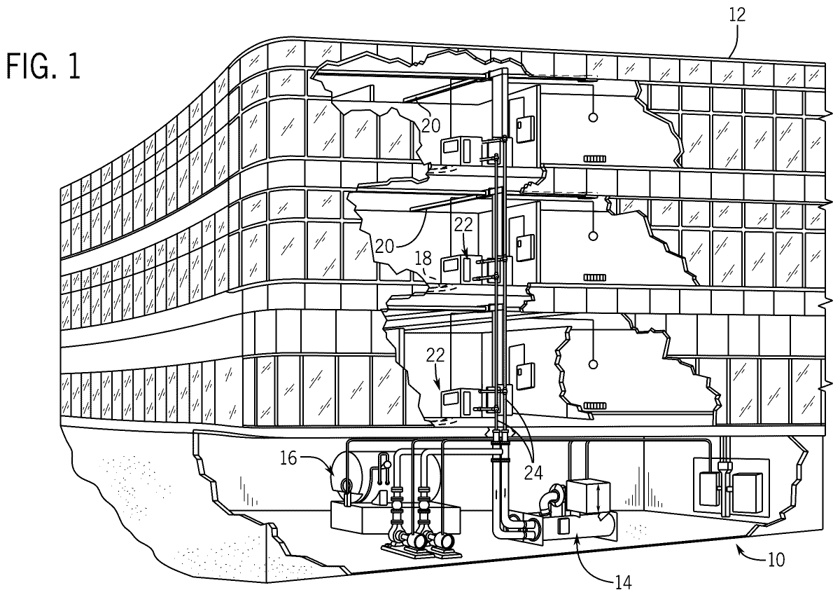

Turning now to the drawings, FIG. 1 is a perspective view of an embodiment of an environment for a heating, ventilation, air conditioning, and refrigeration (HVAC&R) system 10 in a building 12 for a typical commercial setting. The HVAC&R system 10 may include a vapor compression system 14 (e.g., a heat pump system, a chiller system) that supplies a conditioned liquid, which may be used to heat and/or cool the building 12. The HVAC&R system 10 may also include a boiler 16 to supply warm liquid to heat the building 12 and an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or heated and/or chilled liquid from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors. Further, the HVAC&R system 10 may be implemented to provide conditioning (e.g., refrigeration, heating) in other applications, such as food and beverage refrigeration, industrial process refrigeration, district heating, and so forth. Indeed, it should be appreciated that the disclosed systems and methods may be utilized with any suitable HVAC&R system 10 that operates with a working fluid (e.g., refrigerant, ammonia, heat transfer fluid) and a process liquid (e.g., oil).

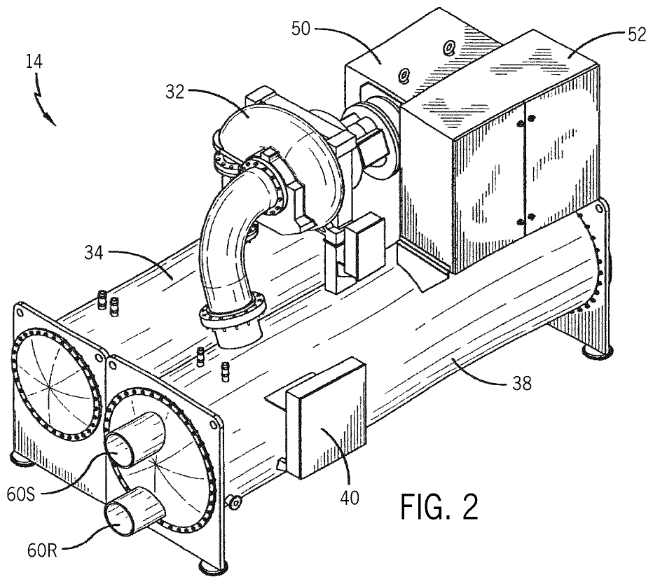

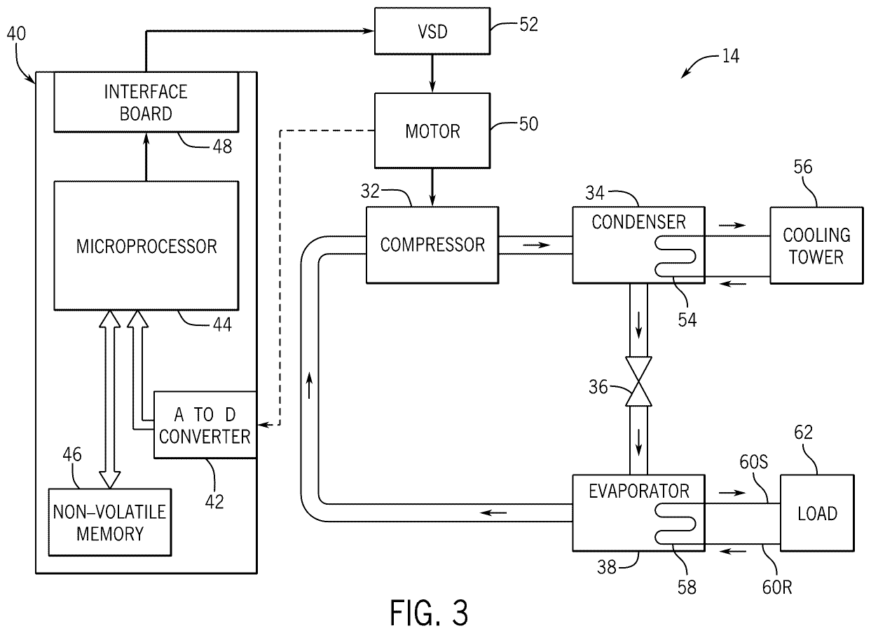

FIGS. 2 and 3 are embodiments of the vapor compression system 14 that can be used in the HVAC&R system 10. The vapor compression system 14 may circulate a working fluid (e.g., a heat transfer fluid, ammonia, a refrigerant) through a circuit starting with a compressor 32. The circuit may also include a condenser 34, an expansion valve(s) or device(s) 36, and an evaporator 38. The vapor compression system 14 may further include a control panel 40 that has an analog to digital (A/D) converter 42, a microprocessor 44, a non-volatile memory 46, and/or an interface board 48.

Some examples of fluids that may be used as working fluids in the vapor compression system 14 are “natural” refrigerants, such as ammonia (NH3) (e.g., R-717), water vapor (e.g., R-718), or carbon dioxide (CO2) (e.g., R-744), hydrofluorocarbon (HFC) based refrigerants, such as R-410A, R-407, R-134a, or hydrofluoro olefin (HFO), hydrocarbon based refrigerants, or any other suitable working fluid.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 and may be powered by a variable speed drive (VSD) 52. The VSD 52 receives alternating current (AC) power having a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of motor that can be powered by a VSD or directly from an AC or DC power source, such as a switched reluctance motor, an induction motor, an electronically commutated permanent magnet motor, or another suitable motor.

The compressor 32 is configured to compress a working fluid vapor and deliver the vapor to the condenser 34 through a discharge passage. In some embodiments, the compressor 32 may be a screw compressor, a scroll compressor, a centrifugal compressor, or a reciprocating compressor. The working fluid vapor delivered by the compressor 32 to the condenser 34 may transfer heat to a cooling or conditioning fluid (e.g., water or air) in the condenser 34. The working fluid vapor may condense to a working fluid liquid in the condenser 34 due to thermal heat transfer with the conditioning fluid. The liquid working fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies a cooling fluid to the condenser 34. However, in other embodiments or applications, the condenser 34 may receive and heat a conditioning fluid that is supplied to a load to provide heating to the load.

The liquid working fluid delivered to the evaporator 38 may absorb heat from another fluid, which may or may not be the same cooling or conditioning fluid used in the condenser 34. The liquid working fluid in the evaporator 38 may undergo a phase change from the liquid working fluid to a working fluid vapor. As shown in the illustrated embodiment of FIG. 3, the evaporator 38 may include a tube bundle 58 having a supply line 60S and a return line 60R connected to a cooling load 62. The conditioning fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the conditioning fluid in the tube bundle 58 via thermal heat transfer with the working fluid. The tube bundle 58 in the evaporator 38 can include a plurality of tubes and/or a plurality of tube bundles. In any case, the vapor working fluid exits the evaporator 38 and returns to the compressor 32 by a suction line to complete the cycle.

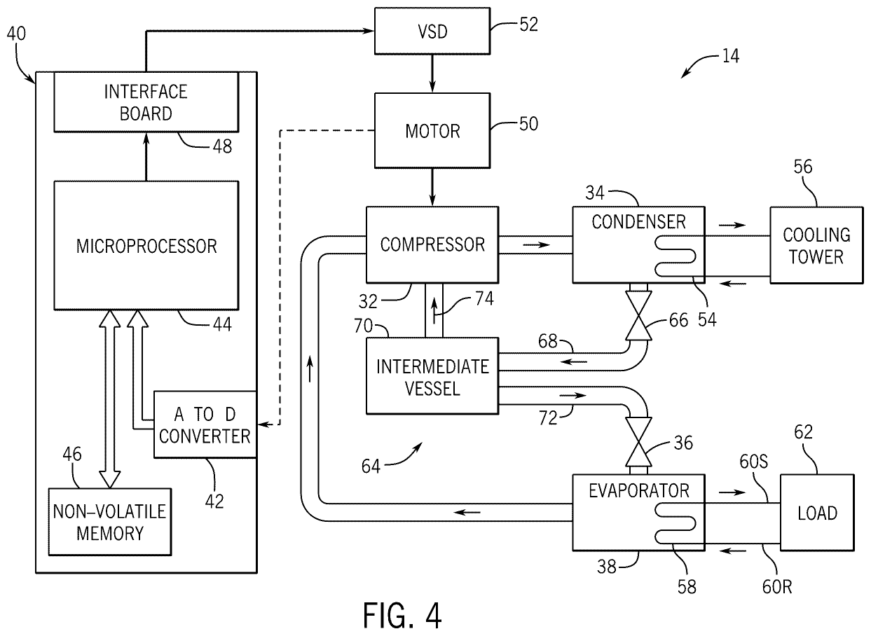

FIG. 4 is a schematic of the vapor compression system 14 with an intermediate circuit 64 incorporated between condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler, an economizer, etc.). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid working fluid received from the condenser 34. During the expansion process, a portion of the liquid may vaporize, and thus, the intermediate vessel 70 may be used to separate the vapor from the liquid received from the first expansion device 66.

Additionally, the intermediate vessel 70 may provide for further expansion of the liquid working fluid because of a pressure drop experienced by the liquid working fluid when entering the intermediate vessel 70 (e.g., due to a rapid increase in volume experienced when entering the intermediate vessel 70). The vapor in the intermediate vessel 70 may be drawn by the compressor 32 through a suction line 74 of the compressor 32. In other embodiments, the vapor in the intermediate vessel may be drawn to an intermediate stage of the compressor 32 (e.g., not the suction stage). The liquid that collects in the intermediate vessel 70 may be at a lower enthalpy than the liquid working fluid exiting the condenser 34 due to expansion in the expansion device 66 and/or the intermediate vessel 70. The liquid from intermediate vessel 70 may then flow in line 72 through a second expansion device 36 to the evaporator 38.

It should be appreciated that any of the features described herein may be incorporated with the vapor compression system 14 or any other suitable HVAC&R systems. For example, the present techniques may be incorporated with any HVAC&R system having a process liquid system, including heat pump systems, chiller systems, and so forth. Further, as mentioned above, the present techniques may be incorporated with HVAC&R systems that utilize any suitable working fluid, such as ammonia (NH3), as a working fluid.

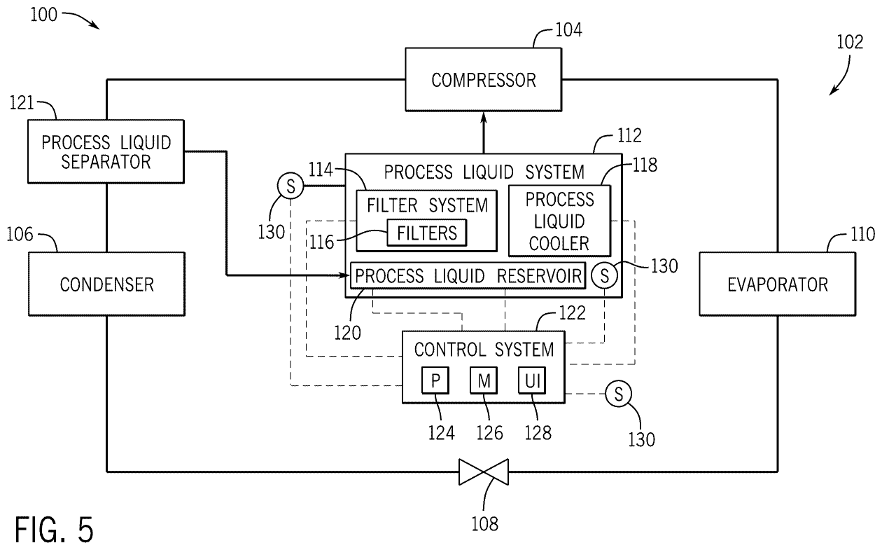

With the foregoing in mind, FIG. 5 is a schematic of an embodiment of a heating, ventilation, air conditioning, and refrigeration (HVAC&R) system 100, such as a heat pump system (e.g., heat pump). The HVAC&R system 100 includes elements similar to those described above. For example, the HVAC&R system 100 includes a working fluid circuit 102 (e.g., vapor compression circuit) having a compressor 104 (e.g., a screw compressor), a condenser 106, an expansion valve 108, and an evaporator 110. The working fluid circuit 102 may circulate a working fluid (e.g., ammonia) therethrough to enable heat transfer between the working fluid and one or more additional fluids, such as a conditioning fluid, a cooling fluid, another suitable fluid, or any combination thereof. In some embodiments, the HVAC&R system 100 may be a heat pump configured to operate in a heating mode to provide heating to a load and in a cooling mode to provide cooling to a load. For example, the HVAC&R system 100 may be a component of a district heating system and may be operated to heat a conditioning fluid circulated through the condenser 106 to absorb heat from the working fluid circulated through the condenser 106 The HVAC&R system 100 also includes a process liquid system 112 configured to supply a process liquid (e.g., enhancing liquid, oil) to the compressor 104. For example, the compressor 104 may include one or more components (e.g., screw, impeller, piston, crankshaft, etc.) configured to move during operation of the compressor 104. The process liquid system 112 may therefore supply the process liquid to the compressor 104 (e.g., to screws of the compressor 104) to facilitate movement of such components, sealing between components, cooling of components, and so forth. The process liquid system 112 may also be configured to receive process liquid from the compressor 104 and/or another portion of the HVAC&R system 100 and to condition the process liquid for resupply and reuse by the compressor 104. In the illustrated embodiment, the process liquid system 112 includes a filter system 114 (e.g., process liquid filter system) having filters 116 (e.g., a plurality of filters, process liquid filters, oil filters, lubricant filters). The filter system 114 (e.g., filters 116) is configured to receive a flow of process liquid (e.g., from the compressor 104) and filter or remove impurities and/or other particles that may be entrained within the process liquid. In accordance with present techniques, the filter system 114 is configured to enable continued operation of the HVAC&R system 100 during maintenance (e.g., servicing, reconditioning, replacement, repair, etc.) of one or more filters 116 of the filter system 114. Details of the filter system 114 are described further below.

In the illustrated embodiment, the process liquid system 112 also includes a process liquid cooler 118 and a process liquid reservoir 120. As will be appreciated, process liquid may be received from a process liquid separator 121 disposed along the working fluid circuit 102. The process liquid separator 121 may be configured to separate process liquid from other fluids or elements that may mix within the process liquid during operation of the HVAC&R system 100. For example, in some instances, an amount of the working fluid circulated through the working fluid circuit 102 may mix with process liquid, such as within the compressor 104. Accordingly, the process liquid separator 121 may operate to separate the process liquid from the working fluid. The process liquid and the working fluid may then be separately directed toward suitable locations within the HVAC&R system 100. For example, the process liquid separator 121 may direct the process liquid to the process liquid system 112, such as the process liquid reservoir 120, which may be configured to store process liquid within the process liquid system 112.

The HVAC&R system 100 may also include a control system 122 (e.g., controller, automation controller, control board) configured to regulate operation of one or more components of the HVAC&R system 100, such as the compressor 104, the expansion valve 108, components of the process liquid system 112 (e.g., filter system 114, process liquid cooler 118), and/or any other components of the HVAC&R system 100. The control system 122 may be configured (e.g., programmed) to perform any and/or all of the functions and operations described further below. In some embodiments, the control system 122 may include processing circuitry 124, such as a microprocessor, which may execute software for controlling the components of the HVAC&R system 100 (e.g., process liquid system 112, filter system 114). The processing circuitry 124 may include multiple microprocessors, one or more “general-purpose” microprocessors, one or more special-purpose microprocessors, and/or one or more application specific integrated circuits (ASICS), or some combination thereof. For example, the processing circuitry 124 may include one or more reduced instruction set (RISC) processors.

The control system 122 may also include a memory device 126 (e.g., a memory) that may store information, such as instructions, control software, look up tables, configuration data, etc. The memory device 126 may include a volatile memory, such as random access memory (RAM), and/or a nonvolatile memory, such as read-only memory (ROM). The memory device 126 may store a variety of information and may be used for various purposes. For example, the memory device 126 may store processor-executable instructions including firmware or software for the processing circuitry 124 execute, such as instructions for controlling components of the HVAC&R system 100. In some embodiments, the memory device 126 is a tangible, non-transitory, machine-readable-medium that may store machine-readable instructions for the processing circuitry 124 to execute. The memory device 126 may include ROM, flash memory, a hard drive, or any other suitable optical, magnetic, or solid-state storage medium, or a combination thereof. The memory device 126 may store data, instructions, and any other suitable data.

Further, the control system 122 may include a user interface 128. The user interface 128 may be configured to receive a user input to enable one or more operations or functions of the control system 122. For example, the user interface 128 may be configured to receive one or more user inputs indicative of operating parameters of the HVAC&R system 100, indicative of commands to adjust operation of the HVAC&R system 100 (e.g., filter system 114), and so forth. To this end, the user interface 128 may include any suitable input devices, such as a button, a dial, a touchscreen, a switch, a keypad, another suitable input device, or any combination thereof. In some embodiments, the user interface 128 may be a remote user device and/or a portable user device (e.g., mobile phone, tablet, desktop computer, etc.) configured to communicatively couple, such as via a wired and/or wireless connection, to the processing circuitry 124. Based on input received via the user interface 128, the processing circuitry 124 may execute instructions (e.g., stored on the memory device 126) to perform and/or adjust one or more operations and/or operating parameters of the HVAC&R system 100 (e.g., process liquid system 112, filter system 114). In some embodiments, the user interface 128 may include one or more output devices, such as a display, a visual indicator, an audio emitter, or any combination thereof, configured to output an indication of an operating parameter or status of the HVAC&R system (e.g., filter system 114).

In some embodiments, the control system 122 may also include one or more sensors 130 configured to detect one or more operating parameters (e.g., one or more operating parameter values) of the HVAC&R system 100. Indeed, the one or more sensors 130 may be configured to detect any suitable operating parameter of the HVAC&R system 100 (e.g., process liquid system 112, filter system 114). For example, one or more of the sensors 130 may be configured to detect a pressure of the working fluid, a temperature of the working fluid, a pressure of the process liquid, a temperature of the process liquid, a position of a valve of the filter system 114, a flow rate of the process liquid through the filter system 114 (e.g., one or more of the filters 116), a composition of the process liquid (e.g., within the filter system 114), presence of another fluid within the filter system 114, a pressure within the filter system 114 (e.g., one or more of the filters 116 or filter modules), a speed of the compressor 104, an operating state or status of a component of the HVAC&R system 100, another suitable operating parameter, or any combination thereof. It should be appreciated that the one or more sensors 130 may be configured to detect any suitable operating parameter to enable the operations and functionalities described herein. The control system 122 may be configured to receive data and/or feedback from the one or more sensors 130 indicative operating parameter values detected by the one or more sensors 130. Based on the operating parameter values, the control system 122 may implement or execute a control action, output a notification or alert (e.g., via the user interface 128), and/or otherwise adjust operation of the HVAC&R system 100 and the components thereof.

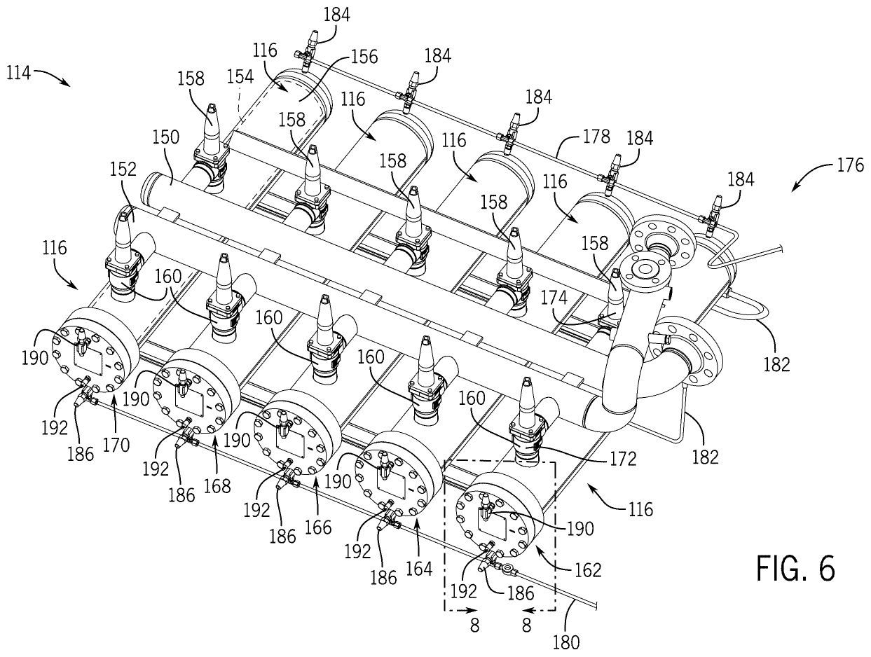

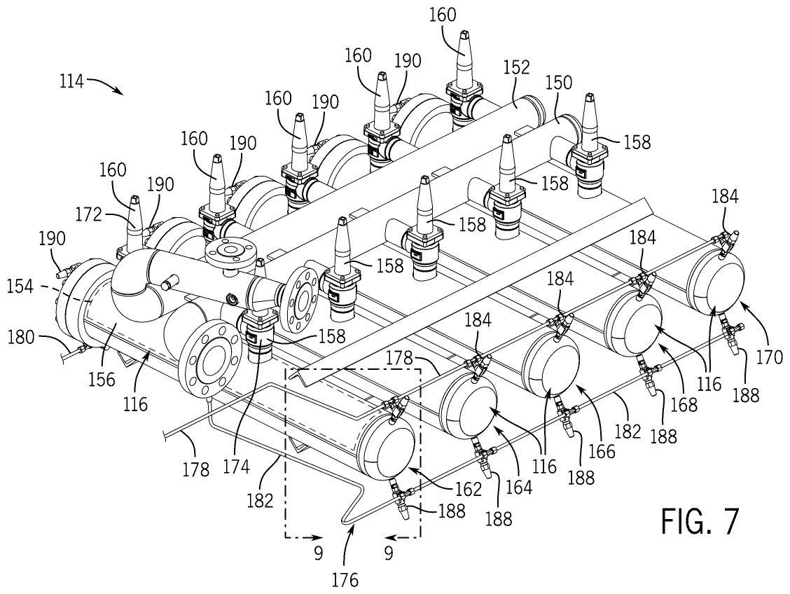

FIG. 6 is a perspective view of an embodiment of the filter system 114 of the process liquid system 112, which may be incorporated with an embodiment of the HVAC&R system 100, in accordance with the present techniques. FIG. 7 is another perspective view of the embodiment of the filter system 114 illustrated in FIG. 6. As mentioned above, the filter system 114 is configured to enable continued operation of the HVAC&R system 100 (e.g., working fluid circuit 102) during performance of maintenance and other procedures on the filter system 114. In particular, the filter system 114 is configured to maintain operation to filter a process liquid of the process liquid system 112, and thereby enable continued operation of the HVAC&R system 100, during maintenance procedures performed on one or more of the filters 116 of the filter system 114. FIGS. 6 and 7 are discussed concurrently below.

As shown, the filter system 114 includes the plurality of filters 116 (e.g., filter modules, filter assemblies). Each filter 116 is configured to receive process liquid (e.g., a respective flow of process liquid) and to filter the process liquid to remove impurities and/or other particles from the process liquid. To this end, the filters 116 are arranged in a parallel configuration (e.g., relative to flow of process liquid through the filters 116 and/or filter system 114). The filter system 114 also includes an inlet manifold 150 and an outlet manifold 152. Each filter 116 is fluidly coupled to the inlet manifold 150 and the outlet manifold 152. The inlet manifold 150 is configured to receive a flow of process liquid (e.g., unfiltered process liquid) and to direct (e.g., divert, distribute) the process liquid to two or more of the filters 116 in parallel with one another. For example, the inlet manifold 150 may receive the flow of process liquid (e.g., unfiltered process liquid) from the compressor 104, the process liquid cooler 118, or another portion of the HVAC&R system 100. However, as discussed further below, a particular or selected one of the filters 116 may not receive process liquid from the inlet manifold 150 during operation of the filter system 114. Each filter 116 is configured to direct the process liquid therethrough to filter impurities and/or other particles from the process liquid. To this end, each filter 116 includes a filter media 154 (e.g., filter element, filter cartridge) disposed within a respective filter housing 156 (e.g., cannister) of the filter 116. The outlet manifold 152 is configured to receive process liquid (e.g., filtered process liquid) from each filter 116. The filtered process liquid may be directed by the outlet manifold 152 to a suitable location of the HVAC&R system 100, such as the compressor 104 (e.g., a manifold of the compressor 104).

To control flow of process liquid from the inlet manifold 150 into the filters 116, each filter 116 includes an inlet valve 158 fluidly coupled between the inlet manifold 150 and the filter housing 156 of the filter 116. Similarly, each filter 116 includes an outlet valve 160 configured to control flow of process liquid out of the filter housing 156 and into the outlet manifold 152. The inlet valve 158 of each filter 116 is adjustable between an open position to enable flow of process liquid into the corresponding filter 116 and a closed position to block flow of process liquid into the corresponding filter 116. The inlet valve 158 may also be adjustable to a plurality of positions between the open position and the closed position to adjust a flow rate of process liquid into the corresponding filter 116. Similarly, the outlet valve 160 of each filter 116 is adjustable between an open position to enable flow of process liquid out of the corresponding filter 116 and a closed position to block flow of process liquid out of the corresponding filter 116, and the outlet valve 160 may also be adjustable to a plurality of positions between the open position and the closed position to adjust a flow rate of process liquid out of the corresponding filter 116. In the illustrated embodiment, the filter system 114 includes five filters 116 arranged in parallel with one another. That is, the filter system 114 includes a first filter 162, a second filter 164, a third filter 166, a fourth filter 168, and a fifth filter 170. However, other embodiments of the filter system 114 may include other numbers of filters 116, such as two, three, four, six, seven, or more filters 116. A particular number of the filters 116 included in the filter system 114 may be selected based on any suitable factors, such as a process liquid demand of the HVAC&R system 100 (e.g., the compressor 104), a type of the process liquid, a size of each filter 116, and so forth.

In accordance with present techniques, at least one of the filters 116 of the filter system 114 is maintained in an idle or non-operating (e.g., non-filtering) state during operation of the filter system 114. For example, in the illustrated embodiment, the first filter 162 may be maintained in an idle state, condition, and/or configuration, whereby the first filter 162 does not operate to receive unfiltered process liquid and discharge filtered process liquid, while remaining filters 116 of the filter system 114 (e.g., second filter 164, third filter 166, fourth filter 168, and fifth filter 170) receive unfiltered process liquid and discharge filtered process liquid. The at least one filter 116 (e.g., the first filter 162) may be maintained in the idle state during normal operation of the HVAC&R system 100 (e.g., filter system 114), such as operation of the HVAC&R system 100 during which maintenance procedures are not performed on the filter system 114 and/or filters 116. To maintain the first filter 162 in the idle state, a first outlet valve 172 of the first filter 162 may be transitioned to and/or maintained in a closed position to block discharge of process liquid from the first filter 162 into the outlet manifold 152. Process liquid flow through the first filter 162 is therefore blocked. However, in the idle state of the first filter 162, a first inlet valve 174 of the first filter 162 may be maintained in an open position to enable pressurization of the first filter 162 (e.g., pressurization within the filter housing 156 of the first filter 162). In other words, process liquid may flow into the filter housing 156 of the first filter 162 when the first filter 162 is in the idle state, but the first filter 162 may not filter and discharge filtered process liquid (e.g., via the first outlet valve 172). In this way, a volume within the filter housing 156 of the first filter 162 is not isolated from the filter system 114, which may avoid entrapment of fluids (e.g., process liquid, gases) within the first filter 162.

The filter system 114 (e.g., process liquid filter system) also includes other components to enable performance of maintenance procedures on at least one of the filters 116 (e.g., process liquid filters) while also enabling continued operation of the filter system 114 to filter the process liquid and thereby enable continued (e.g., uninterrupted) operation of the HVAC&R system 100. For example, the filter system 114 includes a purge system 176 (e.g., drain system, purge and drain system) configured to enable purging of process liquid from one or more of the filters 116 during maintenance procedures (e.g., filter media 154 removal, replacement, etc.) of the one or more filters 116. In the illustrated embodiment, the purge system 176 includes a purge inlet conduit 178 (e.g., inlet line, inlet manifold), a purge discharge conduit 180 (e.g., discharge line, drain conduit), and a purge recirculation conduit 182 (e.g., internal return conduit, internal drain conduit).

The purge inlet conduit 178, the purge discharge conduit 180, and the purge recirculation conduit 182 are each configured to fluidly couple to each of the filters 116 (e.g., filter housing 156, internal volume of the filter housing 156). More specifically, each filter 116 includes a respective purge inlet valve 184 configured to selectively fluidly couple the purge inlet conduit 178 to the corresponding filter 116 (e.g., filter housing 156), a respective purge discharge valve 186 configured to selectively fluidly couple the corresponding filter 116 (e.g., filter housing 156) to the purge discharge conduit 180, and a respective drain valve 188 (e.g., internal drain valve, purge drain valve) configured to selectively fluidly couple the corresponding filter 116 (e.g., filter housing 156) to the purge recirculation conduit 182. In some embodiments, each filter 116 may further include an evacuation valve 190 and/or a sampling valve 192 (e.g., process liquid sampling valve). Details and operation of the purge system 176 are described further below.

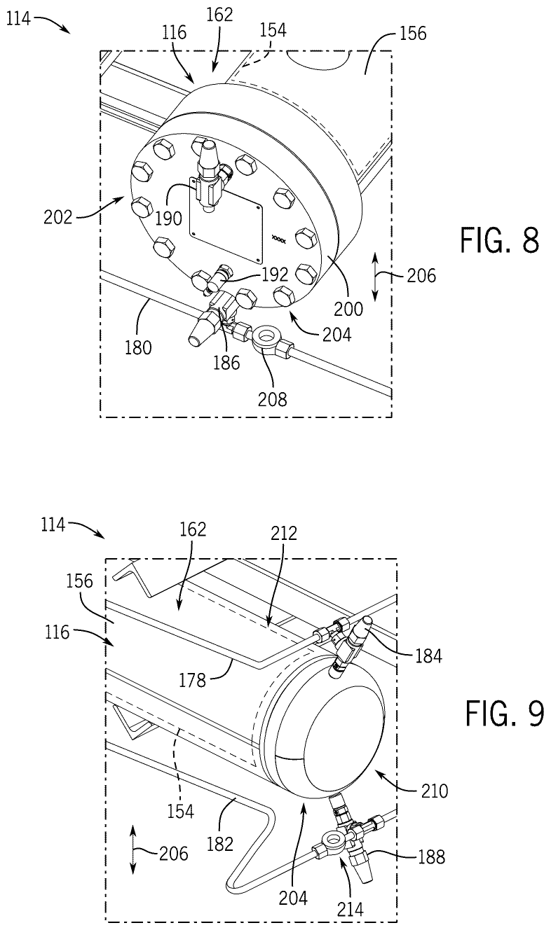

FIG. 8 is an expanded perspective view, taken within line 8-8 of FIG. 6, of the first filter 162 of the filter system 114, illustrating components of the first filter 162 and the purge system 176. The features and operations discussed below may similarly be incorporated with each filter 116 in the filter system 114. As discussed above, the first filter 162 includes the filter housing 156 configured to receive and enclose the filter media 154 of the first filter 162. The first filter 162 also includes a cover 200 (e.g., end cap, end plate) secured to the filter housing 156 at a first end 202 (e.g., first longitudinal end, discharge end) of the filter housing 156. The cover 200 is removably secured (e.g., removably attached) to the filter housing 156. For example, the cover 200 may be removably coupled to the filter housing 156 via mechanical fasteners, such as bolts, screws, clamps, another suitable type of fastener, or any combination thereof. During a maintenance procedure of the first filter 162, such as during repair, reconditioning, and/or replacement of the filter media 154 within the first filter 162, the cover 200 may be removed from the filter housing 156 to enable removal of the filter media 154 from the filter housing 156 of the first filter 162. It should be appreciated that each filter 116 of the filter system 114 may similarly include a corresponding embodiment of the cover 200 configured to removably couple to the respective filter housing 156 of each filter 116.

As discussed above, the first filter 162 also includes the purge discharge valve 186 configured to selectively fluidly couple the first filter 162 (e.g., filter housing 156, internal volume of the filter housing 156) to the purge discharge conduit 180. In particular, the purge discharge valve 186 is disposed at the first end 202 of the filter housing 156 and may therefore be more adjacent to the outlet valve 160 of the first filter 162 and more distal to the inlet valve 158 of the first filter 162. Thus, the purge discharge valve 186 may be configured to selectively discharge process liquid (e.g., filtered process liquid) from the filter housing 156 that has been filtered by the filter media 154. The purge discharge valve 186 may be selectively actuated to an open position during maintenance (e.g., a maintenance stage) of the first filter 162, such as during a procedure to replace the filter media 154 within the first filter 162, to enable drainage of process liquid within the first filter 162 to the purge discharge conduit 180. To this end, the purge discharge valve 186 may be fluidly coupled to the filter housing 156 at or adjacent a base 204 (e.g., relative to a vertical axis 206) of the filter housing 156. Accordingly, the purge discharge valve 186 may more readily or effectively enable drainage of process liquid from the first filter 162 to the purge discharge conduit 180. During other operations or time periods (e.g., when a procedure to replace the filter media 154 within the first filter 162 is not performed), the purge discharge valve 186 may be maintained in a closed position.

The first filter 162 also includes the evacuation valve 190 and the sampling valve 192. In the illustrated embodiment, the evacuation valve 190 is mounted to the cover 200 and is configured to selectively fluidly couple the filter housing 156 (e.g., internal volume of the filter housing 156) to an external conduit or system. In other embodiments, the evacuation valve 190 may be mounted to the filter housing 156 instead of the cover 200. The evacuation valve 190 may be actuated during maintenance (e.g., a maintenance stage) of the first filter 162, such as during replacement of the filter media 154 within the first filter 162. As described further below, the evacuation valve 190 may be configured to discharge another fluid (e.g., purge gas, working fluid, ammonia) that is directed into the filter housing 156 during the maintenance procedure. The sampling valve 192 may be actuated to an open position to enable removal of a portion (e.g., sample, small amount) of process liquid from the first filter 162, such as to perform testing, analysis, and/or other evaluation of the process liquid within the first filter 162. The sampling valve 192 may otherwise be maintained in a closed position during operation of the filter system 114.

In the illustrated embodiment, the purge system 176 also includes a sight glass 208 (e.g., first sight glass, filtered process liquid sight glass, discharge sight glass) disposed along the purge discharge conduit 180. In particular, the sight glass 208 is disposed along the purge discharge conduit 180 downstream of the purge discharge valves 186 of the filters 116, including the first filter 162, relative to a flow direction of fluid (e.g., process liquid, purge gas, working fluid) through the purge discharge conduit 180. The sight glass 208 is configured to enable an operator (e.g., user, technician) of the HVAC&R system 100 to view and/or monitor fluid flow along the purge discharge conduit 180, such as during maintenance procedures performed on the filter system 114, as described further below.

FIG. 9 is an expanded perspective view, taken within line 9-9 of FIG. 7, of the first filter 162 of the filter system 114, illustrating additional components of the first filter 162 and the purge system 176. In particular, the illustrated embodiment shows a second end 210 (e.g., second longitudinal end, inlet end), opposite the first end 202, of the filter housing 156. As discussed above, the first filter 162 includes the purge inlet valve 184 mounted to the filter housing 156 and configured to selectively fluidly couple the first filter 162 (e.g., filter housing 156, internal volume of the filter housing 156) to the purge inlet conduit 178. With the purge inlet valve 184 disposed at the second end 210 of the filter housing 156, the purge inlet valve 184 may be more adjacent to the inlet valve 158 of the first filter 162 and more distal to the outlet valve 160 of the first filter 162. The purge inlet valve 184 may be selectively actuated to an open position during maintenance (e.g., a maintenance stage) of the first filter 162, such as during a procedure to replace the filter media 154 within the first filter 162, to direct a fluid, such as a purge gas, from the purge inlet conduit 178 into the filter housing 156. The purge inlet valve 184 may be fluidly coupled to the filter housing 156 at or adjacent a top 212 (e.g., relative to the vertical axis 206) of the filter housing 156 opposite the base 204. During other operations or time periods (e.g., when a procedure to replace the filter media 154 within the first filter 162 is not performed), the purge inlet valve 184 may be maintained in a closed position.

As shown, the first filter 162 also includes the drain valve 188 (e.g., recirculation valve) configured to selectively fluidly couple the first filter 162 (e.g., filter housing 156, internal volume of the filter housing 156) to the purge recirculation conduit 182. The drain valve 188 is also disposed at the second end 210 of the filter housing 156 and may therefore be more adjacent to the inlet valve 158 of the first filter 162 and more distal to the outlet valve 160 of the first filter 162. Thus, the drain valve 188 may be configured to selectively discharge process liquid (e.g., unfiltered process liquid) from the filter housing 156 that has not been filtered by the filter media 154. The drain valve 188 may be selectively actuated to an open position during maintenance (e.g., a maintenance stage) of the first filter 162, such as during a procedure to replace the filter media 154 within the first filter 162, to enable drainage of process liquid within the first filter 162 to the purge recirculation conduit 182. To this end, the drain valve 188 may be fluidly coupled to the filter housing 156 at or adjacent the base 204 (e.g., relative to the vertical axis 206) of the filter housing 156. Accordingly, the drain valve 188 may more readily or effectively enable drainage of process liquid from the first filter 162 to the purge recirculation conduit 182. As discussed further below, the purge recirculation conduit 182 may direct the process liquid (e.g., unfiltered process liquid) from the first filter 162 undergoing the maintenance procedure to the inlet manifold 150. In this way, the process liquid may be recirculated to other filters 116 of the filter system 114 that are in operation during the maintenance procedure of the first filter 162 to enable filtration of the process liquid and avoid disposal or discarding of the process liquid. During other operations or time periods (e.g., when a procedure to replace the filter media 154 within the first filter 162 is not performed), the drain valve 188 of the first filter 162 may be maintained in a closed position.

In the illustrated embodiment, the purge system 176 also includes a sight glass 214 (e.g., second sight glass, unfiltered process liquid sight glass, recirculation sight glass) disposed along the purge recirculation conduit 182. In particular, the sight glass 214 is disposed along the purge recirculation conduit 182 downstream of the drain valves 188 of the filters 116, including the first filter 162, relative to a flow direction of fluid (e.g., process liquid, purge gas, working fluid) through the purge recirculation conduit 182. The sight glass 214 is configured to enable an operator (e.g., user, technician) of the HVAC&R system 100 to view and/or monitor fluid flow along the purge recirculation conduit 182, such as during maintenance procedures performed on the filter system 114, as described further below.

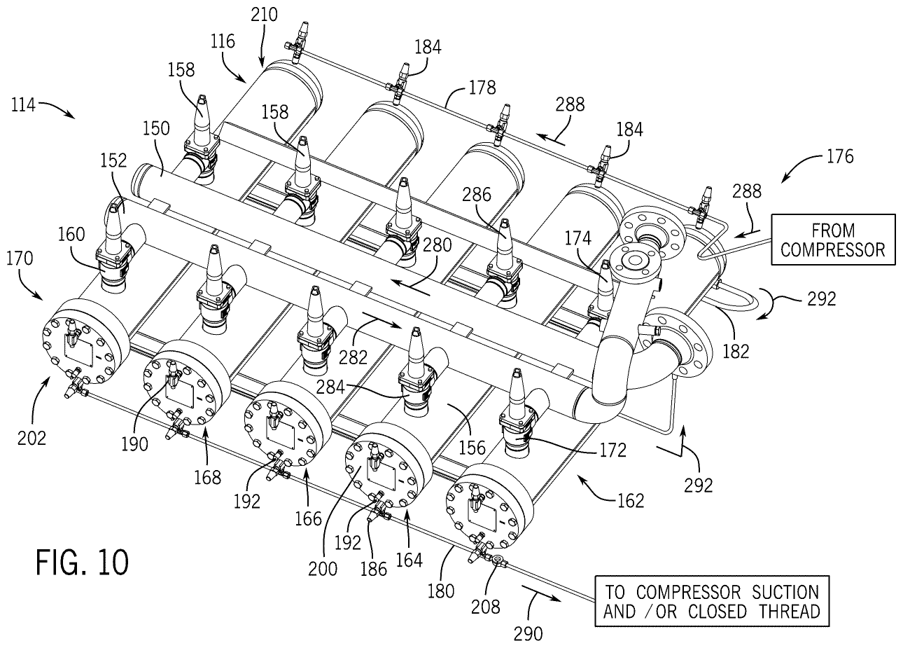

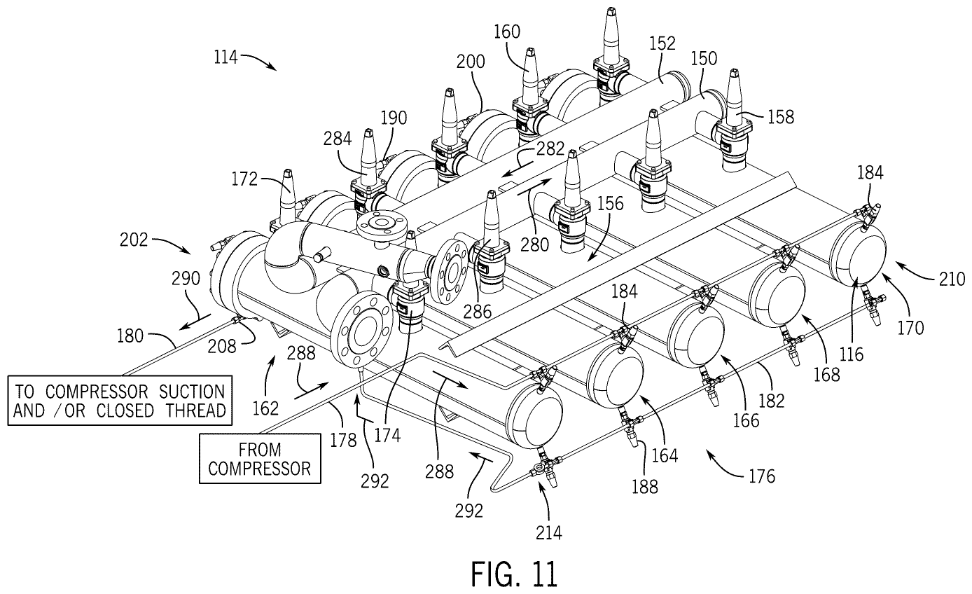

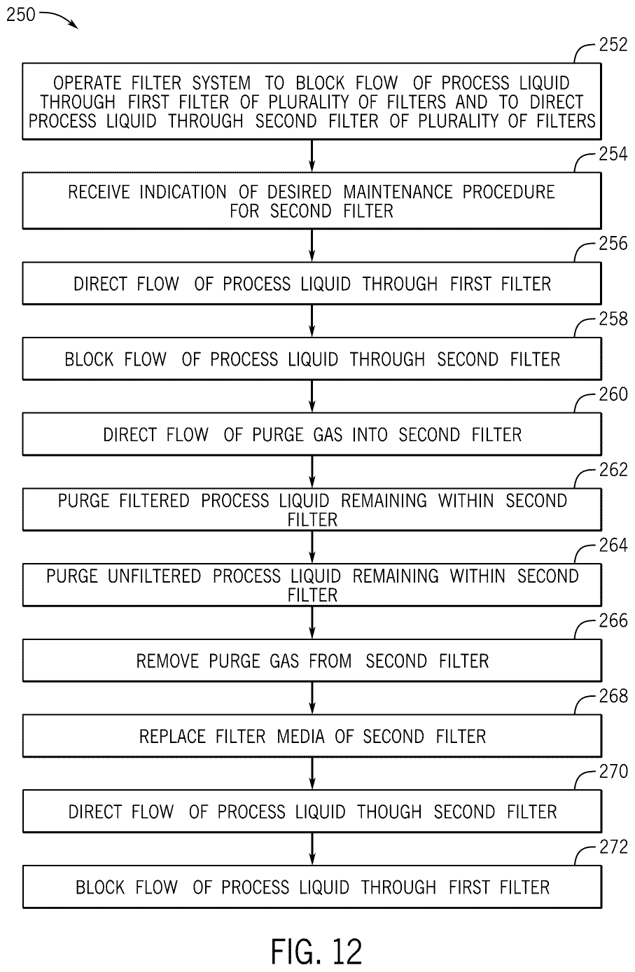

FIG. 10 is a perspective view of an embodiment of the filter system 114 of the process liquid system 112, illustrating flow of fluid through the filter system 114, in accordance with the present techniques. FIG. 11 is another perspective view of the embodiment of the filter system 114 illustrated in FIG. 10, illustrating flow of fluid through the filter system 114. The embodiments of FIGS. 10 and 11 include elements and element numbers similar to those described above. Additionally, FIG. 12 is a flow chart of an embodiment of a method 250 for operating (e.g., controlling) the filter system 114 during a maintenance procedure. Specifically, the method 250 is directed to adjustment and operation of the filter system 114 during replacement of the filter media 154 of one of the filters 116. In the manner described below, the filter system 114 and the method 250 enable continued operation of the filter system 114 to filter process liquid, and thereby enable continued (e.g., uninterrupted) operation of the HVAC&R system 100 during replacement of the filter media 154 of one of the filters 116. FIG. 12 is described with concurrent reference to FIGS. 10 and 11 below.

It should be noted that the steps of the method 250 discussed below may be performed in any suitable order and are not limited to the order shown in the illustrated embodiment of FIG. 11. Moreover, it should be noted that additional steps of the method 250 may be performed and certain steps of the method 250 may be omitted, in certain embodiments. Still further, it should be appreciated that certain of the steps of the method 250 may be performed concurrently with other steps. In some embodiments, one or more steps (e.g., some or all of the steps) of the method 250 may be executed by the processing circuitry 124 of the control system 122 (e.g., via execution of processor-executable instructions stored on the memory device 126) and/or by other suitable processing circuitry of the HVAC&R system 100. Additionally or alternatively, one or more steps of the method 250 may be performed manually, such as by an operator or technician of the HVAC&R system 100 (e.g., filter system 114).

As mentioned above, the method 250 is directed to adjustment and operation of the filter system 114 during replacement of the filter media 154 of one of the filters 116 of the filter system 114 while enabled continued (e.g., uninterrupted) of the filter system 114 and the HVAC&R system 100. However, it should be appreciated that the method 250 and/or one or more steps of the method 250 may be repeated to enable replacement of the filter media 154 of other (e.g., all) filters 116 of the filter system 114. In the illustrated embodiment, the method 250 begins with block 252. At block 252, the filter system 114 is operated to block flow of process liquid (e.g., oil) through a first filter (e.g., first filter 162, idle filter, service filter) and to direct process liquid through a second filter (e.g., second filter 164) of the filter system 114. Operation of the filter system 114, as described by block 252, may be referred to herein as a “normal operating mode” of the filter system 114. In the normal operating mode, unfiltered process liquid is directed through the inlet manifold 150, as indicated by arrow 280, to the filters 116 in operation (e.g., second filter 164), and filtered process liquid received from the filters 116 in operation is directed through the outlet manifold 152, as indicated by arrow 282.

As discussed above, in accordance with present techniques, at least one filter 116 of the filter system 114 is maintained in an idle or non-filtering state during the normal operating mode of the filter system 114. For example, in the illustrated embodiments of FIGS. 10 and 11, the second filter 164, the third filter 166, the fourth filter 168, and the fifth filter 170 may each direct process liquid therethrough (e.g., from the inlet manifold 150 to the outlet manifold 152) during the normal operating mode of the filter system 114. Thus, the respective inlet valve 158 and outlet valve 160 associated with each of the second filter 164, the third filter 166, the fourth filter 168, and the fifth filter 170 may be maintained (e.g., via the control system 122) in open positions in the normal operating mode. Conversely, the first filter 162 may be maintained in an idle or non-filtering state in the normal operating mode. Specifically, as discussed above, the first outlet valve 172 of the first filter 162 may be maintained (e.g., via the control system 122) in a closed position to block discharge of filtered process liquid from the first filter 162 into the outlet manifold 152 in the normal operating mode. However, the first inlet valve 174 of the first filter 162 may be maintained in an open position (e.g., via the control system 122) to enable pressurization of the first filter 162 and avoid entrapment of liquid and/or gas within the volume of the first filter 162 in the normal operating mode.

At block 254, an indication is received that a maintenance procedure for a second filter (e.g., the second filter 164) of the filter system 114 is desired. For example, the maintenance procedure may be repair, reconditioning, and/or replacement of the filter media 154 of the second filter 164. In some embodiments, the indication of the desired maintenance procedure may be identified (e.g., received) based on a predetermined time interval associated with desired replacement of the filter media 154 of one or more of the filters 116. Additionally or alternatively, the indication of the desired maintenance procedure may be identified and/or received based on an operating parameter of the filter system 114 and/or the HVAC&R system 100. For example, one or more of the sensors 130 may detect an operating parameter of the filter system 114 that is indicative of desired replacement of the filter media 154 of one or more of the filters 116. In some embodiments, the operating parameter may be a pressure differential (e.g., pressure drop) of the process liquid across the filter system 114 and/or across one or more of the filters 116. The pressure differential may be indicative of a difference between the pressure of the process liquid within the inlet manifold 150 (e.g., detected by one sensor 130) and the pressure of the process liquid within the outlet manifold 152 (e.g., detected by another sensor 130). In some embodiments, the control system 122 may be configured to receive data from one or more sensors 130, determine a detected pressure differential of the process liquid across the filter system 114, and compare the detected pressure differential to a pressure differential threshold value. Based on a determination that the detected pressure differential exceeds (e.g., is less than) the pressure differential threshold value, the control system 122 may determine that replacement of the filter media 154 of one or more of the filters 116 and/or other maintenance procedure is desired. In some embodiments, the control system 122 may be configured to output a notification or alert, such as via the user interface 128, to indicate that the maintenance procedure is desired.

In response to the indication that a maintenance procedure of the filter system 114 is desired, the maintenance procedure may be performed. For example, at block 256, flow of process liquid may be directed through (e.g., into and out of) the first filter 162 (e.g., idle filter, service filter). To this end, the first outlet valve 172 of the first filter 162 may be adjusted from the closed position toward an open position. In some embodiments, the control system 122 may be configured to adjust the position of the first outlet valve 172 toward the open position. Additionally or alternatively, the position of the first outlet valve 172 may be adjusted manually, such as by a technician. With the first outlet valve 172 opened, all filters 116 of the filter system 114 may be in operation to filter the process liquid. In some instances, enabling operation (e.g., filtering operation) of the first filter 162 along with the remaining filters 116 of the filter system 114 may cause a pressure drop of the process liquid across the filter system 114 to decrease.

With the first filter 162 operating to filter the process liquid, another filter 116 of the filter system 114 may be selected to undergo a maintenance procedure, such as replacement of the filter media 154 of the filter 116. Operation of the filter 116 selected for maintenance may be suspended to enable performance of the maintenance procedure. However, because operation of the first filter 162 (e.g., idle filter) is enabled, the filter system 114 may continue to operate to filter and supply process liquid (e.g., to the compressor 104) at a desired capacity. In this way, operation of the filter system 114, the compressor 104, and the HVAC&R system 100 generally may continue without interruption during maintenance procedures performed on another filter 116, thereby improving service and/or satisfaction of a load on the HVAC&R system 100.

As an example, the second filter 164 may be selected to undergo a maintenance procedure (e.g., filter media 154 replacement), and operation of the second filter 164 may be suspended. In particular, as indicated by block 258, flow of process liquid through the second filter 164 may be blocked or suspended. For example, a second outlet valve 284 (e.g., outlet valve 160) of the second filter 164 may be adjusted from an open position toward a closed position. Additionally, a second inlet valve 286 (e.g., inlet valve 158) of the second filter 164 may be adjusted from an open position toward a closed position. The positions of the second outlet valve 284 and the second inlet valve 286 may be adjusted by the control system 122, by an operator or technician, or in another suitable manner.

Additionally, a flow of purge gas may be directed into the second filter 164, as indicated by block 260. For example, the purge inlet valve 184 (e.g., second purge inlet valve) of the second filter 164 may be adjusted at least partially from a closed position toward an open position (e.g., via the control system 122, manually via a technician) to enable flow of the purge gas into the second filter 164 from the purge inlet conduit 178. The purge inlet valve 184 of the second filter 164 may be actuated to an at least partially opened position during transition of the second outlet valve 284 and the second inlet valve 286 toward closed positions, in some embodiments. The purge gas may be a pressurized gas supplied to the purge inlet conduit 178 via any suitable source. In some embodiments, the purge gas may be pressurized gaseous working fluid (e.g., ammonia) that is directed into and along the purge inlet conduit 178, as indicated by arrows 288, from the compressor 104 (e.g., from a discharge side of the compressor 104).

Once the second outlet valve 284 and the second inlet valve 286 are actuated to fully closed positions, the purge inlet valve 184 of the second filter 164 may be actuated to a fully open position to direct the purge gas into the filter housing 156 of the second filter 164. Directing the purge gas into the second filter 164 may force at least a portion of process liquid remaining within the filter housing 156 of the second filter 164 to flow out of the second filter 164. For example, the purge gas may initially force filtered process liquid to flow out of the second filter 164, as indicated by block 262. To this end, the purge discharge valve 186 of the second filter 164 may be actuated to an open position (e.g., manually, via the control system 122) to enable discharge of filtered process liquid from the second filter 164. In other words, the purge gas is directed into the filter housing 156 via the purge inlet valve 184 at the second end 210 of the filter housing 156, and filtered process liquid that has flowed through and/or across the filter media 154 of the second filter 164 may be forced out of the second filter 164 via the purge discharge valve 186. The filtered process liquid may then be directed along the purge discharge conduit 180, as indicated by arrow 290. In some embodiments, the purge discharge conduit 180 may direct the filtered process liquid to the compressor 104 (e.g., an inlet of the compressor 104, compressor 104 suction) and/or to a closed thread of the compressor 104. Thus, the filtered process liquid within the second filter 164 may be recirculated for further use within the HVAC&R system 100 instead of wasted or discarded, which would otherwise involve addition of new process liquid into the filter system 114 (e.g., the second filter 164). In this way, present embodiments conserve process liquid and reduce operating and maintenance costs associated with the HVAC&R system 100.

In some instances, flow of the filtered process liquid discharged from the second filter 164 along the purge discharge conduit 180 may be monitored. For example, an operator or technician may observe the flow of the filtered process liquid, which may have a foamy appearance in some instances, along the purge discharge conduit 180 via the sight glass 208, such as to verify that filtered process liquid continues to be discharged from the second filter 164 along the purge discharge conduit 180. Additionally or alternatively, one of the sensors 130 of the control system 122 may be coupled to and/or disposed along the purge discharge conduit 180 and may be configured to detect a characteristic (e.g., quality, constituency, composition) of the fluid flowing along the purge discharge conduit 180. In such embodiments, the control system 122 may receive feedback from the sensor 130 and determine that process liquid (e.g., filtered process liquid) continues to be discharged from the second filter 164 via the purge discharge conduit 180 or is no longer being discharged from the second filter 164 via the purge discharge conduit 180.

Eventually it may be observed and/or determined that filtered process liquid is no longer discharged from the second filter 164 via the purge discharge conduit 180 and that primarily or purely purge gas is flowing along the purge discharge conduit 180. Based on such a determination and/or upon a determination that discharge of filter process liquid via the purge discharge valve 186 is reduced (e.g., substantially reduced, reduced to a threshold amount or level), the purge discharge valve 186 may be actuated toward a closed position (e.g., manually, via the control system 122).

Thereafter, unfiltered process liquid remaining within the second filter 164 may be purged from the second filter 164, as indicated by block 264. Specifically, the drain valve 188 of the second filter 164 may be actuated (e.g., manually, via the control system 122) from a closed position toward an open position. With the drain valve 188 of the second filter 164 in an at least partially open position, the purge gas directed into the second filter 164 via the purge inlet valve may at least partially force unfiltered process liquid within the second filter 164 to flow out of the second filter 164. As the purge inlet valve 184 and the drain valve 188 are both disposed at the second end 210 of the second filter 164, the process liquid forced out of the second filter 164 at the second end 210 may not have been directed across and/or through the filter media 154 and may therefore be unfiltered.

The unfiltered process liquid discharged from the second filter 164 via the drain valve 188 is directed along the purge recirculation conduit 182, as indicated by arrows 292. The purge recirculation conduit 182 may be configured to direct the unfiltered process liquid to the inlet manifold 150 to combine with additional unfiltered process liquid flowing through inlet manifold 150 (e.g., received from the process liquid cooler 118 and/or the compressor 104) upstream of the filters 116. In some applications, a pressure loss within the process liquid cooler 118 upstream of the inlet manifold 150 may facilitate flow of the unfiltered process liquid along the purge recirculation conduit 182 from the second filter 164 to the inlet manifold 150. In the manner described above, the unfiltered process liquid discharged from the second filter 164 may be recirculated and subsequently filtered via filters 116 in operation during the maintenance procedure of the second filter 164. Advantageously, this configuration of the purge system 176 enables a reduction in waste and/or discarding of process liquid during the maintenance procedure of the second filter 164.

As similarly discussed above, flow of the unfiltered process liquid discharged from the second filter 164 along the purge recirculation conduit 182 may be monitored. For example, an operator or technician may observe the flow of the unfiltered process liquid along the purge recirculation conduit 182 via the sight glass 214, such as to verify that unfiltered process liquid continues to be discharged from the second filter 164 along the purge recirculation conduit 182. Additionally or alternatively, one of the sensors 130 of the control system 122 may be coupled to and/or disposed along the purge recirculation conduit 182 and may be configured to detect a characteristic (e.g., quality, constituency, composition) of the fluid flowing along the purge recirculation conduit 182. In such embodiments, the control system 122 may receive feedback from the sensor 130 and determine that process liquid (e.g., unfiltered process liquid) continues to be discharged from the second filter 164 via the purge recirculation conduit 182 or is no longer being discharged from the second filter 164 via the purge recirculation conduit 182.

Once it is observed and/or determined that all, substantially all, or a sufficient amount of unfiltered process liquid remaining within the second filter 164 is purged via the purge recirculation conduit 182, the method 250 may proceed to block 266. At block 266, purge gas within the filter housing 156 of the second filter 164 may be removed. In some instances, the purge gas (e.g., ammonia) removed from the second filter 164 may be discarded or redirected to the working fluid circuit 102 for use as the working fluid. For example, the evacuation valve 190 of the second filter 164 may be utilized to remove purge gas from within the second filter 164 to depressurize the second filter 164. The evacuation valve 190 may be transitioned from a closed position to an open position (e.g., manually, via the control system 122) to discharge the purge gas within the second filter 164. In some embodiments, an evacuation pump (e.g., vacuum pump) may be fluidly coupled to the evacuation valve 190 to draw the purge gas out of the second filter 164, such as until a pressure threshold (e.g., detected by one of the sensors 130, atmospheric pressure) within the second filter 164 is reached.

In some instances, an amount of purge gas that is vented via the evacuation valve 190 may be reduced by first redirecting at least a portion of the purge gas to the working fluid circuit 102. For example, prior to actuation of the evacuation valve 190, the drain valve 188 of the second filter 164 may be closed, and the purge discharge valve 186 may be at least partially re-opened before the purge inlet valve 184 is closed. Accordingly, purge gas within the second filter 164 may be directed along the purge discharge conduit 180 to the compressor 104 suction and/or closed thread of the compressor 104. In some instances, a remaining amount of process liquid within the second filter 164 may be included with the purge gas discharged via the purge discharge valve 186, and any remaining process liquid may be monitored via the sight glass 208. In such instances, the purge inlet valve 184 may be closed once no or substantially no process liquid is observed flowing along the purge discharge conduit 180 (e.g., via the sight glass 208). With the purge inlet valve 184 closed, the pressure within the second filter 164 may be reduced to the pressure of the compressor 104 suction and/or the closed thread of the compressor 104 (i.e., lower than the discharge pressure of the purge gas directed into the second filter 164 via the purge inlet valve 184). Thereafter, the evacuation valve 190 may be opened to vent remaining purge gas within the second filter 164, as described above.

Thereafter, with no or substantially no process liquid and purge gas remaining in the second filter 164, the method 250 may proceed to block 268, and the filter media 154 of the second filter 164 may be replaced. For example, the cover 200 of the second filter 164 may be detached and removed from the filter housing 156 to expose an internal volume of the filter housing 156 and the filter media 154 therein. The filter media 154 may be reconditioned, repair, and/or replaced with new filter media 154. The cover 200 may then be secured to the filter housing 156 with the new filter media 154. In some embodiments, after the new filter media 154 is installed, the method 250 may include a step of depressurizing and/or generating a vacuum within the filter housing 156 of the second filter 164 (e.g., similar to the step at block 266). In this way, air and/or other non-condensable gases may be removed from the internal volume of the filter housing 156 prior to re-introduction of process liquid into the filter housing 156 with the new filter media 154.

The method 250 may then proceed to block 270. At block 270, flow of process liquid may be directed into the filter housing 156 to enable operation of the second filter 164 and filtration of the process liquid via the second filter 164 with the new filter media 154. Specifically, the second inlet valve 286 may be actuated (e.g., manually, via the control system 122) to transition from the closed position to an open position to enable flow of process liquid from the inlet manifold 150 into the second filter 164. In some applications, the second inlet valve 286 may be gradually transitioned from the closed position to the open position to avoid rupture or other degradation to the new filter media 154 within the second filter 164. Similarly, the second outlet valve 284 may be transitioned (e.g., gradually transitioned) from the closed position to an open position to enable discharge of filtered process liquid from the second filter 164.

In some implementations, one or more of the steps of blocks 256 through 270 may be repeated in a similar manner to enable maintenance (e.g., repair and/or replacement of filter media 154) within other filters 116 of the filter system 114, such as the first filter 162, the third filter 166, the fourth filter 168, and/or the fifth filter 170. Subsequently, such as after new filter media 154 are installed in each filter 116, the method 250 may proceed to step 272, whereby flow of process liquid through the first filter 162 is blocked by closing the first outlet valve 172 of the first filter 162. The first inlet valve 174 may be transitioned and/or maintained in an open position to enable pressurization of the first filter 162, as previously discussed. In other words, operation of the filter system 114 may be adjusted to return the first filter 162 (e.g., idle filter, service filter) to an idle, non-operating, and/or non-filtering state, while remaining filters 116 of the filter system 114 may operate to filter the process liquid.

While the discussion above describes the present techniques incorporated with the filter system 114 including the first filter 162 as an idle filter and remaining filters 116 as operating filters, it should be appreciated that other embodiments may include multiple filters 116 implemented as idle filters. Such embodiments may enable performance of maintenance procedures (e.g., filer media 154 repair and/or replacement) on multiple filters 116 simultaneously. For example, a number of idle filters incorporated with the filter system 114 may correspond to (e.g., match, equal) a number of filters 116 for which maintenance procedures may be performed simultaneously.

While only certain features and embodiments of the present disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be noted that the appended claims are intended to cover all such modifications and changes as fall within the true spirit of the present disclosure.

Furthermore, in an effort to provide a concise description of the exemplary embodiments, all features of an actual implementation may not have been described (i.e., those unrelated to the presently contemplated best mode of carrying out the present disclosure, or those unrelated to enabling the claimed embodiments). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A process liquid filter system for a heating, ventilation, air conditioning, and refrigeration (HVAC&R) system, comprising:
a plurality of process liquid filters arranged in parallel with one another relative to flow of process liquid through the process liquid filter system, wherein each process liquid filter of the plurality of process liquid filters comprises an inlet valve configured to receive unfiltered process liquid and an outlet valve configured to discharge filtered process liquid; and
a purge system, comprising:
a respective purge inlet valve coupled to each process liquid filter of the plurality of process liquid filters, wherein each respective purge inlet valve is configured to control flow of a purge gas into the process liquid filter corresponding to the respective purge inlet valve; and
a respective purge discharge valve coupled to each process liquid filter of the plurality of process liquid filters, wherein each respective purge discharge valve is configured to discharge the filtered process liquid from the process liquid filter corresponding to the respective purge discharge valve.

2. The process liquid filter system of claim 1, wherein each inlet valve is configured to receive the unfiltered process liquid from an inlet manifold of the process liquid filter system.

3. The process liquid filter system of claim 2, wherein the inlet manifold is configured to receive the unfiltered process liquid from a process liquid cooler of the HVAC&R system.

4. The process liquid filter system of claim 3, wherein the purge system comprises a respective drain valve coupled to each process liquid filter of the plurality of process liquid filters, and each respective drain valve is configured to discharge the unfiltered process liquid from the process liquid filter corresponding to the respective drain valve.

5. The process liquid filter system of claim 4, wherein the purge system comprises a purge recirculation conduit, and each drain valve is configured to direct the unfiltered process liquid to the inlet manifold.

6. The process liquid filter system of claim 1, wherein the purge system comprises a purge inlet conduit, and each purge inlet valve is configured to receive the purge gas from the purge inlet conduit.

7. The process liquid filter system of claim 6, wherein the purge inlet conduit is configured to receive the purge gas from a compressor of the HVAC&R system.

8. The process liquid filter system of claim 7, wherein the purge gas comprises ammonia.

9. The process liquid filter system of claim 8, wherein the ammonia is a working fluid circulated through a working fluid circuit of a heat pump of the HVAC&R system by the compressor and to transfer heat to a conditioning fluid via a heat exchanger.

10. The process liquid filter system of claim 1, wherein the purge system comprises a purge discharge conduit, and each purge discharge valve is configured to direct the filtered process liquid into the purge discharge conduit.

11. The process liquid filter system of claim 10, wherein the purge discharge conduit is configured to direct the filtered process liquid to a compressor of the HVAC&R system.

12. A method for operating a process liquid filter system for a heating, ventilation, air conditioning, and refrigeration (HVAC&R) system, comprising:
blocking flow of a process liquid through a first process liquid filter of the process liquid filter system and simultaneously directing flow of the process liquid through a second process liquid filter of the process liquid filter system to remove impurities from the process liquid, wherein the first process liquid filter and the second process liquid filter are arranged in parallel with one another relative to flow of the process liquid through the process liquid filter system;
enabling flow of the process liquid through the first process liquid filter of the process liquid filter system;
blocking flow of the process liquid through the second process liquid filter subsequent to enabling flow of the process liquid through the first process liquid filter;
purging the process liquid from the second process liquid filter; and
replacing a filter media of the second process liquid filter with a new filter media.

13. The method of claim 12, wherein purging the process liquid from the second process liquid filter comprises directing a purge gas through the second process liquid filter.

14. The method of claim 13, comprising directing the purge gas from a compressor of the HVAC&R system to the second process liquid filter.

15. The method of claim 12, comprising:
directing the process liquid purged from the second process liquid filter to a compressor of the HVAC&R system;
directing the process liquid purged from the second process liquid filter to the first process liquid filter; or
both.

16. A process liquid filter system for a heating, ventilation, air conditioning, and refrigeration (HVAC&R) system, comprising:
an inlet manifold configured to receive unfiltered process liquid;
an outlet manifold configured to discharge filtered process liquid from the process liquid filter system;
a plurality of process liquid filters arranged in parallel with one another relative to flow of process liquid through the plurality of process liquid filters, wherein each process liquid filter of the plurality of process liquid filters comprises an inlet valve configured to receive the unfiltered process liquid from the inlet manifold and an outlet valve configured to discharge the filtered process liquid to the outlet manifold, wherein each process liquid filter of the plurality of process liquid filters comprises:
a purge inlet valve configured to control flow of a purge gas into the process liquid filter;
a purge discharge valve configured to discharge the filtered process liquid from the process liquid filter; and
a drain valve configured to discharge the unfiltered process liquid from the process liquid filter.

17. The process liquid filter system of claim 16, wherein the purge inlet valve and the drain valve are coupled to the process liquid filter at a first end of the process liquid filter, and the purge discharge valve is coupled to the process liquid filter at a second end of the process liquid filter opposite the first end.

18. The process liquid filter system of claim 16, comprising a purge inlet conduit, wherein each purge inlet valve is configured to receive the purge gas from the purge inlet conduit, and the purge inlet conduit is configured to receive the purge gas from a compressor of a heat pump of the HVAC&R system.

19. The process liquid filter system of claim 18, comprising a purge discharge conduit, wherein each purge discharge valve is configured to direct the filtered process liquid into the purge discharge conduit, and the purge discharge conduit is configured to direct the filtered process liquid to the compressor.

20. The process liquid filter system of claim 19, comprising a purge recirculation conduit, wherein each drain valve is configured to direct the unfiltered process liquid into the purge recirculation conduit, and the purge recirculation conduit is configured to direct the unfiltered process liquid to the inlet manifold upstream of the plurality of process liquid filters.
